(19) United States
(12) Patent Application Publication
(10) Pub. No.: US 2007/0285547 A1
(43) Pub. Date: Dec. 13, 2007

(54) CMOS image sensor array optimization for both bright and low light conditions

(76) Inventors: Edward S. Milligan, Redding, CA (US); Robert C. Glenn, Bend, OR (US)

Correspondence Address: INTEL CORPORATION;c/o INTELLEVATE, LLC, P.O. BOX 52050, MINNEAPOLIS, MN, 55402, US

(21) Appl. No.: 11/443,554

(22) Filed: May 30, 2006

(51) Int. Cl. H04N 5/335

(52) U.S. Cl. 348/308

(57) ABSTRACT

Apparatus, systems and methods for CMOS image sensor array optimization for both bright and low light applications are disclosed. In one implementation, an apparatus includes an imaging array, the array including at least pixels of a first type having a first charge storage capacity and pixels of a second type having a second charge storage capacity. Other implementations are disclosed.

### BACKGROUND

A pixel in a typical complementary metal oxide semiconductor (CMOS) imaging device stores photo-induced charge on a single charge storage element or hold capacitor having a specific capacitance that is substantially the same for all pixels in the device. The amount of charge that the pixel can store, also known as the pixel's “well capacity,” is proportional to the capacitance or “size” of the hold capacitor. There are, however, competing effects that make choosing the size of the hold capacitor a difficult design decision for developers of CMOS imaging devices. On the one hand, larger well capacitance increases the pixel's signal-to-noise ratio (SNR) by permitting the capacitor to store more electrons. Thus, greater well capacitance improves a pixel's bright light imaging response by increasing the pixel's dynamic range. On the other hand, smaller well capacitance improves the pixel's SNR by reducing read error (e.g., kTC noise, etc.). Lowering the read error enhances the pixel's response under low light conditions.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 is a block diagram illustrating an example imaging system in accordance with some implementations of the invention;

FIG. 2 is a block diagram of a portion of a sensor array in accordance with some implementations of the invention;

FIG. 3 is a block diagram of a portion of another sensor array in accordance with some implementations of the invention;

FIG. 4 is a schematic diagram illustrating an implementation of two adjacent pixels of a portion of a sensor array in accordance with some implementations of the invention;

FIG. 5 is a schematic diagram illustrating another implementation of two adjacent pixels of a portion of a sensor array in accordance with some implementations of the invention;

FIG. 6 is a flow chart illustrating a process in accordance with some implementations of the invention;

FIG. 7 is a flow chart illustrating another process in accordance with some implementations of the invention;

FIG. 8 is a flow chart illustrating another process in accordance with some implementations of the invention; and

FIG. 9 is a flow chart illustrating another process in accordance with some implementations of the invention.

### DETAILED DESCRIPTION

The following detailed description refers to the accompanying drawings. The same reference numbers may be used in different drawings to identify the same or similar elements. In the following description specific details may be set forth such as particular structures, architectures, interfaces, techniques, etc. in order to provide a thorough understanding of the various aspects of the claimed invention. However, such details are provided for purposes of explanation and should not be viewed as limiting with respect to the claimed invention. With benefit of the present disclosure it will be apparent to those skilled in the art that the various aspects of the invention claimed may be practiced in other examples that depart from these specific details. Moreover, in certain instances, descriptions of well known devices, circuits, and methods are omitted so as not to obscure the description of the present invention with unnecessary detail.

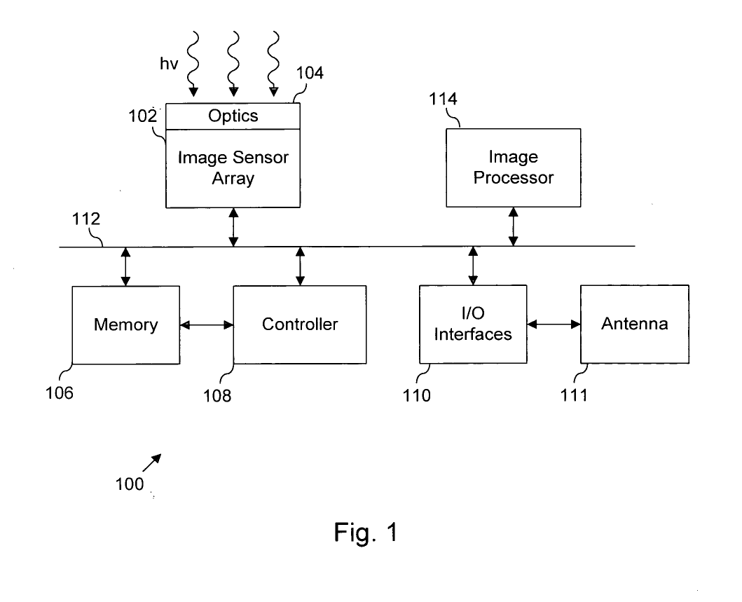

FIG. 1 illustrates an example system 100 in accordance with some implementations of the invention. System 100 includes an image sensor 102, light gathering optics 104, memory 106, a controller 108, one or more input/output (I/O) interfaces 110 (e.g., universal synchronous bus (USB) interfaces, parallel ports, serial ports, wireless communications ports, and/or other I/O interfaces), an image processor 114, and a shared bus or other communications pathway 112 coupling devices 102 and 106-110 together for the exchange of, for example, image data and/or control data. System 100 may also include an antenna 111 (e.g., dipole antenna, narrowband Meander Line Antenna (MLA), wideband MLA, inverted “F” antenna, planar inverted “F” antenna, Goubau antenna, Patch antenna, etc.) coupled to a wireless network interface of I/O interfaces 110.

System 100 may assume a variety of physical manifestations suitable for CMOS image sensor array optimization for both bright and low light applications in accordance with some implementations of the invention. For example, system 100 may be implemented within a digital imaging device (e.g., digital camera, cellular telephone handset, personal digital assistant (PDA), etc.). Moreover, various components of system 100 may be implemented in an integrated configuration rather than as discrete components. For example, memory 106, controller 108 and interfaces 110 may be implemented within one or more semiconductor device(s) and/or integrated circuit (IC) chip(s) (e.g., within a chipset, system-on-a-chip (SOC), etc.). Where system 100 is implemented in a mobile computing device (e.g., PDA) and/or mobile communications device (e.g., cellular telephone handset) antenna 111 may enable wireless communication between system 100 and external devices and/or communications networks. In addition, various components that might be associated with system 100 but are not particularly relevant to the claimed invention (e.g., audio components, display-related logic, etc.) have been excluded from FIG. 1 so as to not obscure the invention.

Image sensor array 102 may include an array of complementary metal oxide semiconductor (CMOS) diode elements or pixels although the invention is not limited in this regard and array 102 may include other types of semiconductor imaging elements incorporating charge storage or hold capacitance.

Light gathering optics 104 may be any collection of light gathering optical elements capable and/or suitable for collecting light and providing that light to sensor 102. Although those skilled in the art will recognize that optics 104 may comprise various optical components and/or arrangement of optical components, the specific nature of optics 104 is not limiting with respect to the invention and hence will not be described in further detail.

Memory 106 may be any device and/or mechanism capable of storing and/or holding imaging data including color pixel data and/or component values, to name a few examples. For example, although the invention is not limited in this regard, memory 106 may be volatile memory such as static random access memory (SRAM) or dynamic random access memory (DRAM), or non-volatile memory such as flash memory.

Controller 108 may include, in various implementations, any collection of logic and/or collection of logic devices capable of manipulating imaging data in order to implement CMOS image sensor array optimization for both bright and low light applications in accordance with some implementations of the invention. For example, controller 108 may be an image controller and/or signal processor. However, the invention is not limited in this regard and controller 108 may be implemented in a general purpose processor, microprocessor, and/or microcontroller to name a few other examples. Further, controller 108 may comprise a single device (e.g., a microprocessor or an application specific IC (ASIC)) or may comprise multiple devices. In one implementation, controller 108 may be capable of performing any of a number of tasks that support processes for implementing CMOS image sensor array optimization for both bright and low light applications. These tasks may include, for example, although the invention is not limited in this regard, downloading microcode, initializing and/or configuring registers, and/or interrupt servicing.

In some implementations, controller 108 may include control logic and/or processing logic. As will be explained in further detail below, the control logic may be capable of applying appropriate control signals to array 102, while the processing logic may be capable of processing output data of array 102 in a manner consistent with the control signals applied to array 102. In others implementations, controller 108 may include processing logic while array 102 may include control logic. In further implementations, array 102 may incorporate both such processing logic and/or control logic in whole or in part. In other words, while controller 108 is shown as a distinct device in system 100 this is not meant to imply that controller 108 and/or any collection of control and/or processing logic that controller 108 may comprise cannot in whole or part be incorporated into a single device, such as an IC, along with array 102. Clearly the invention is not limited by which device incorporates the control and/or processing logic that may be associated with system 100. Moreover, the terms processing logic and/or control logic as used herein include any suitable combination of hardware, firmware and/or software needed to implement the claimed invention.

Image processor 114 may include any collection of control and/or processing logic suitable for processing images provided by array 102 and/or controller 108 such that those images are in a suitable format for use by other devices that may be coupled to system 100 but are not shown in FIG. 1 (such as a display or a printer). In some implementations, processor 114 may comprise a display processor and/or controller at least capable of processing the output of array 102 to place it in a form suitable for displaying on a monitor or other type of display (not shown). For example, processor 114 may be capable of manipulating the resolution of the array's image data.

In other implementations, processor 114 may comprise a printer processor and/or controller at least capable of processing the output of array 102 to place it in a form suitable for printing on a printer or similar device (not shown). For example, processor 114 may be capable of color converting image data provided by array 102. In further implementations, processor 114 may comprise a multimedia processor or controller at least capable of multimedia processing the output of array 102. For example, processor 114 may be capable of blending an array's image data with other image data. Processor 114 may also be capable of interpolating image data produced by array 102.

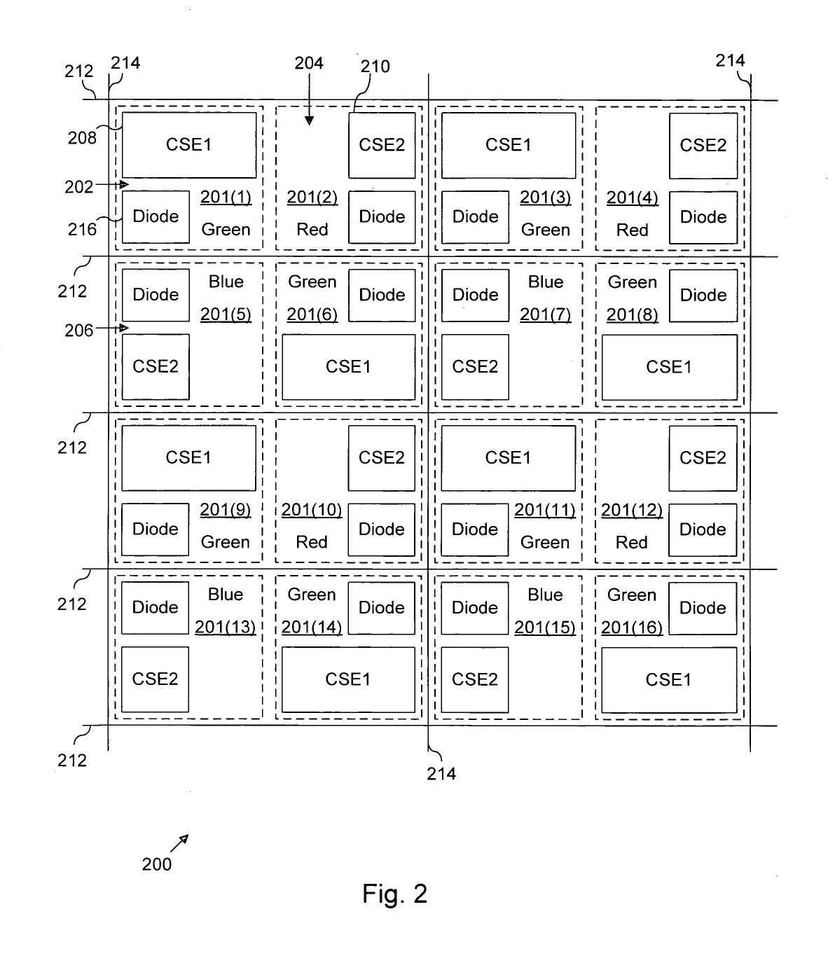

FIG. 2 illustrates a portion 200 of an image sensor array, such as array 102 of FIG. 1, in accordance with some implementations of the invention. Array portion 200 illustrates a contiguous block of sixteen imaging pixels 201(1)-201(16). Those skilled in the art will recognize that pixels 201(1)-201(16) are positioned in a Bayer pattern in which pixels 201(1), 201(3), 201(6), 201(8), 201(9), 201(11), 201(14) and 201(16) are situated under green color filters 202; while pixels 201(2), 201(4), 201(10), and 201(12) are situated under red color filters 204; and pixels 201(5), 201(7), 201(13), and 201(15) are situated under blue color filters 206.

In accordance with some implementations of the invention, pixels 201(1), 201(3), 201(6), 201(8), 201(9), 201(11), 201(14), and 201(16) are of a first type having larger charge storage capacity in the form of larger charge storage elements (CSE) 208 (labeled “CSE1”), while pixels 201(2), 201(4), 201(5), 201(7), 201(10), 201(12), 201(13) and 201(15) are of a second type having smaller charge storage capacity or smaller CSEs 210 (labeled “CSE2”). In some implementations, the charge storage ratio of CSE 208 to CSE 210 may be at least 1:1.0625 although the invention is not limited to a specific charge storage or capacitance ratio. In other words, CSE 208 and CSE 210 may have substantially different charge storage capacities.

In addition, CSEs 208 and/or 210 may comprise any devices or structures capable of storing or accumulating charge. Thus, for example, CSEs 208 and/or 210 may comprise potential well storage devices that capture converted charge resulting from semiconductor photonic interactions. For instance, CSEs 208/210 may comprise photonic charge storage elements formed as part of the photodiode 216 of imaging pixels 201(1)-201(16). Alternatively, CSEs 208/210 may comprise capacitors, such as thin-film capacitors. However, these are merely example implementations of CSEs 208/210 and the invention is not limited with regard to a particular type or structure of charge storage elements 208/210.

Array portion 200 also includes segments of row address lines 212 and column address lines 214 and, in addition, each pixel 201(1)-201(16) includes a photodiode 216. As can be seen from portion 200, an array in accordance with some implementations of the invention may comprise rows and columns each having alternating pixels with different charge storage capacities. Those skilled in the art will recognize that some conventional components of an imaging sensor pixel (e.g., row select devices, analog-to-digital converters, shutter and reset devices etc.) that are not particularly germane to the invention have been excluded from FIG. 2 in the interests of clarity.

Array portion 200, while schematically representational of some components of an imaging array in accordance with some implementations of the invention, is offered for the purposes discussion and does not, necessarily, represent a detailed schematic diagram of portion 200. For example, those skilled in the art will recognize that portion 200 omits imaging pixel circuit components such as reset and shutter devices, etc. In addition, while FIG. 2 shows representative array portion 200 having pixels 201(1)-(16) arranged in a Bayer pattern the invention is not limited in this regard and other arrangements of pixels having larger CSEs and pixels having smaller CSEs may be employed without departing from the scope and spirit of the invention. For example, the invention may be implemented using monochromatic imaging arrays although in that case a color filter array is not necessary. Moreover, the relative sizes of CSEs 208 and 210 as shown in FIG. 2 are not meant to imply a specific charge storage ratio.

While portion 200 has two CSE values, CSE1 and CSE2, the invention is not limited to particular CSE values or to specific numbers or combinations of different CSE values. Thus, for example, in some implementations of the invention, more than two CSE values may be utilized. Moreover, while the green pixels of portion 200 include the larger CSE1 values while the red and blue pixels include the smaller CSE2 values, the invention is not limited in this regard and more than one CSE value can be associated with each pixel color of an array.

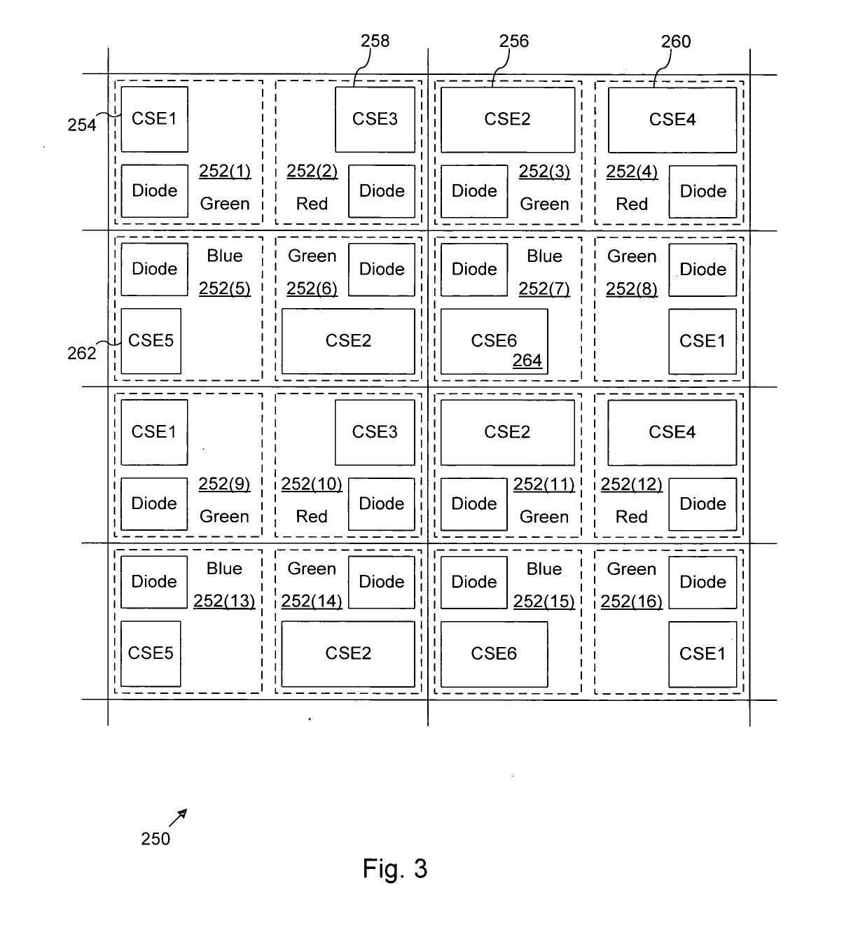

For example, FIG. 3 illustrates an array portion 250 in accordance with some implementations of the invention. While portion 250 shares many features in common with portion 200, portion 250 is distinguishable from portion 200 in that portion 250 includes green pixels 252(1), 252(8), 252(9), and 252(16) having a first CSE value (CSE1); green pixels 252(3), 252(6), 252(11), and 252(14) having a second CSE value (CSE2); red pixels 252(2) and 252(10) having a third CSE value (CSE3), red pixels 252(4) and 252(12) having a fourth CSE value (CSE4); blue pixels 252(5) and 252(13) having a fifth CSE value (CSE5); and blue pixels 252(7) and 252(14) having a sixth CSE value (CSE6).

Thus as shown, portion 250 includes a total of six CSE values (CSE1-CSE6) distributed across portion 250 such that each type of color pixel, red, green, or blue, is associated with at least two different CSE values. As noted above with respect to FIG. 2, the relative sizes of the CSEs in FIG. 3 are not intended to limit the invention to particular CSE values or ratios thereof. In addition, the pixel layouts of FIGS. 2 and 3, while conforming to a Bayer pattern, are not intended to limit the invention to a particular layout of imaging pixels nor is the total number of different sizes of CSEs shown in FIGS. 2 or 3 intended to limit the invention to particular values of CSEs or to particular distributions of differently values CSEs.

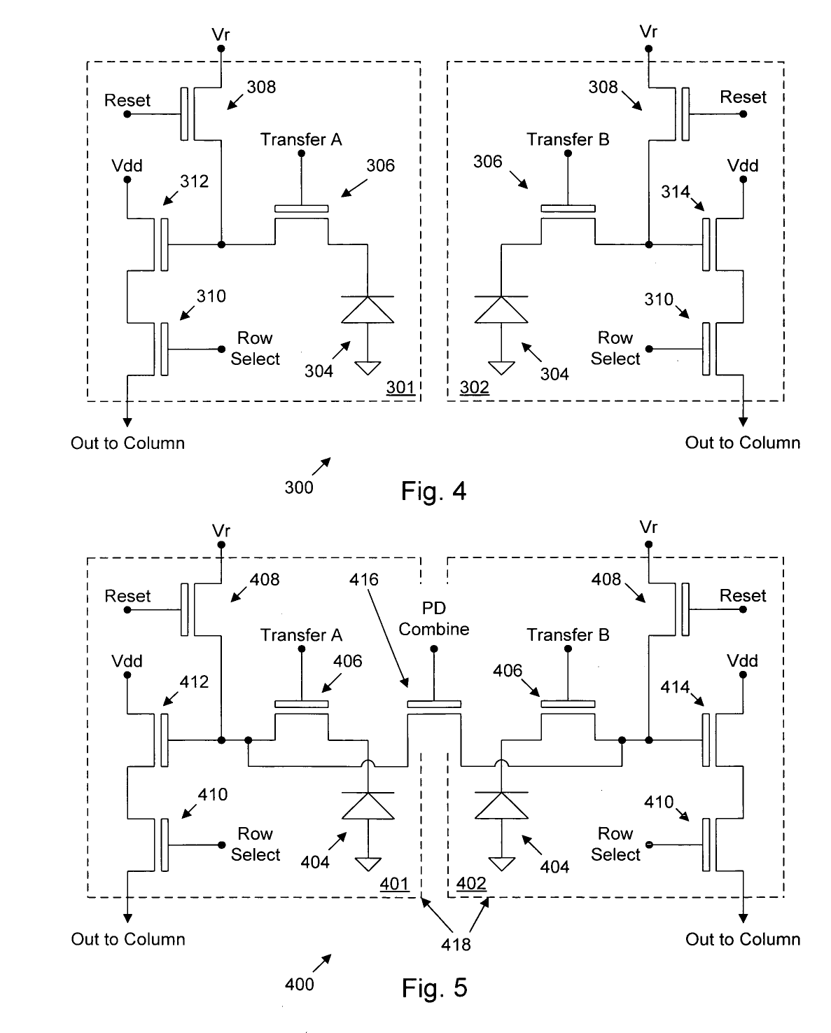

FIG. 4 illustrates an implementation of two adjacent pixels 301 and 302 of a pixel array portion 300 in accordance with some implementations of the invention, such as any of adjacent pixels of the array portions 200 and 250 of FIGS. 2 and 3. Each pixel 301/302 includes a photodiode 304, a charge transfer device 306, a reset device 308, and a row select device 310. In accordance with some implementations of the invention, pixel 301 includes a CSE 312 having a substantially smaller charge storage capacity than that of the CSE 314 of pixel 302. For example, the charge storage capacity of device 312 might be suitable for storing a maximum charge corresponding to a 5-bit maximum pixel well capacity while the charge storage capacity of device 314 might be suitable for storing a maximum charge corresponding to a 10-bit maximum pixel well capacity. However, in accordance with the invention, the charge storage capacities of devices 312 and 314 or the ratio thereof is not limited to any particular value(s).

FIG. 5 illustrates another arrangement of two adjacent pixels 401 and 402 of another pixel array portion 400 in accordance with some other implementations of the invention, such as any of adjacent pixels of the array portions 200 and 250 of FIGS. 2 and 3. Each pixel 401/402 includes a photodiode 404, a charge transfer device 406, a sample/hold reset device 408, and a row select device 410. In accordance with some implementations of the invention, pixel 401 includes a CSE 412 having a substantially smaller charge storage capacity than that of the CSE 414 of pixel 402. In addition, in accordance with some implementations of the invention, portion 400 includes a photodiode (PD) combining device 416 coupling pixel 401 to pixel 402 to create a pixel pair 418. Thus, an imaging array in accordance with some implementations of the invention may include a plurality of combining devices 416 coupling adjacent pixels, such as pixels 401 and 402, to form a plurality of pixel pairs 418.

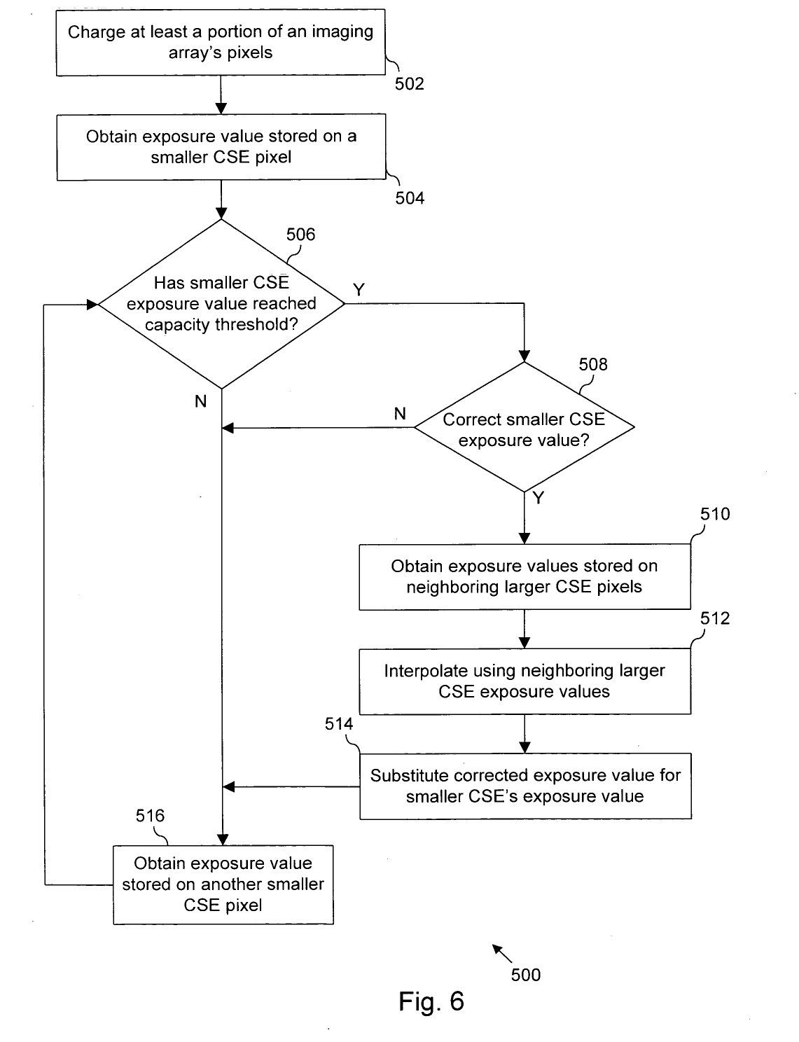

FIG. 6 is a flow diagram illustrating a process 500 for implementing CMOS image sensor array optimization for both bright and low light conditions in accordance with some implementations of the claimed invention. While, for ease of explanation, process 500, and associated processes, may be described with regard to system 100 of FIG. 1, respective array portions 200 and/or 250 of FIGS. 2-3 and/or the adjacent pixels of FIGS. 4-5, the invention is not limited in this regard and other processes or schemes supported and/or performed by appropriate devices and/or combinations of devices in accordance with the claimed invention are possible.

Process 500 may begin with charging at least a portion of an imaging array's pixels [act 502]. In some implementations, control logic in controller 108 may initiate a charge transfer control signal to at least a portion of array 102. In some implementations, the control logic may supply a signal to charge transfer devices 306/406 of pixels 201(1)-201(16) thereby charging those pixel's CSEs (e.g., CSEs 312/412 for pixels 201(1), 201(3), 201(6), 201(8), 201(9), 201(11), 201(14), and 201(16)); and CSEs 314/414 for pixels 201(2), 201(4), 201(5), 201(7), 201(10), 201(12), 201(13) and 201(15)) with photocurrent supplied by those pixel's photodiodes. When charged, those CSEs may be considered as storing a value (i.e., voltage) proportional to that charge. For example, a small CSE, such as CSE 312 of pixel 301, may store exposure values up to 5-bits in magnitude, while a larger CSE, such as CSE 314 of pixel 302, may store exposure values up to 10-bits in magnitude. Once again, however, the invention is not limited to particular charge storage values or ratios thereof.

Process 500 may continue with obtaining the exposure value stored on a smaller CSE [act 504]. In some implementations this may be done by having control logic in controller 108 supply a row select control signal to at least a portion of array 102 along one or more of row address lines 212. That is, the control logic may supply a row select control signal to device 310 of smaller CSE pixel 301 thereby causing pixel 301 to supply the value stored on smaller CSE 312 to one of column lines 214 and ultimately to processing logic in controller 108. Those skilled in the art will recognize that there may be intervening circuitry and/or logic (such as analog-to-digital converter circuitry, etc.) facilitating the transfer of the smaller CSE charge storage or exposure value (i.e., the voltage corresponding thereto) between column lines 214 and the output data path(s) of array 102 that are not particularly germane to the invention and that have therefore not been included in FIGS. 1-5 in the interests of clarity.

Once the processing logic has obtained the smaller CSE exposure value for a smaller CSE pixel, a determination may then be made as to whether the smaller CSE exposure value has reached a capacity threshold [act 506]. In some implementations, processing logic in controller 108 may compare the value obtained in act 504 with a predetermined capacity threshold value. For example, for smaller CSE pixels such as pixel 301 having a 5-bit maximum capacity, a predetermined threshold value may correspond to at least a 5-bit or ½ full scale value. In other words, the predetermined threshold value may represent a charge storage or exposure value (i.e., voltage value) at or near saturation (i.e., at full capacity or in overflow condition) of that pixel's response.

If the result of act 506 is a positive determination (i.e., if the smaller CSE exposure value meets or exceeds the predetermined capacity threshold value) then process 500 may continue with an assessment of whether to correct the smaller CSE exposure value [act 508]. One way to do this is to have the processing logic of controller 108 make the determination of act 508. If the result of act 510 is negative (i.e., if controller 108 determines that the smaller CSE exposure value is not to be corrected), then process 500 may continue with the obtaining of another smaller CSE exposure value [act 516] and acts 506 and 508 may be performed for that new smaller CSE's exposure value.

If the result of act 508 is a positive determination then process 500 may continue with the obtaining of the exposure values stored on two or more of the neighboring larger CSE pixels [act 510]. In some implementations this may be done by having control logic in controller 108 supply a row select control signal to at least two of the larger CSE pixels in array 102 along one or more of row address lines 212. For example, the control logic may, in part, supply a row select control signal to device 310 of pixel 302 (i.e., as one of the larger CSE pixel neighbors of pixel 301) thereby causing pixel 302 to supply the exposure value stored on larger CSE 314 to one of column lines 214 and ultimately to processing logic in controller 108. To complete the example using array portion 200 of FIG. 2, if pixel 201(7) represents smaller CSE pixel 301 and pixel 201(8) represents larger CSE pixel 302, then to accomplish act 510, controller 108 may likewise obtain the CSE exposure values of one or more of the remaining larger CSE pixel neighbors 201(3), 201(6), and/or 201(11) of smaller CSE pixel 201(7). As noted above, those skilled in the art will recognize that there may be intervening circuitry and/or logic facilitating the transfer of the larger CSE exposure values between array 102 and controller 108 that are not particularly germane to the invention and that have therefore not been included in FIGS. 1-5 in the interests of clarity.

Process 500 may continue with interpolation using the neighboring larger CSE exposure values [act 512]. In some implementations, if processing logic in controller 108 has determined in act 508 that the smaller CSE's exposure value should be corrected value then that logic may undertake the interpolation of act 512 using the larger CSE exposure values obtained in act 510. For instance, referring again to example array portion 200 of FIG. 2, if the smaller CSE exposure value obtained in act 504 and assessed as meeting or exceeding the predetermined threshold in act 506 was obtained from pixel 201(7) then the processing logic may interpolate between two or more of the larger CSE exposure values of pixels 201(3), 201(6), 201(8) and/or 201(11) to obtain an corrected exposure value. For example, the processing logic may determine the average value (i.e., mean value) from two or more of the larger CSE exposure values of pixels 201(3), 201(6), 201(8) and/or 201(11) and use that value as the corrected exposure value. The invention is not limited by the type of interpolation employed in act 512 and other methods of interpolation, such as determining the median value of the neighboring larger CSE exposure values, may, for example, be implemented in act 512 in accordance with the invention.

Process 500 may continue with the substitution of a corrected exposure value for the smaller CSE's exposure value [act 514]. One way to do this is to have the processing logic of controller 108 replace the smaller CSE exposure value obtained in act 504 with the corrected exposure value determined in act 512. Another way to implement act 514 is to have processing logic of controller 108 determine a correction factor by comparing the smaller CSE exposure value obtained in act 504 to the corrected exposure value determined in act 512 and use that correction factor to modify the smaller CSE exposure value obtained in act 504.

Process 500 may continue with obtaining of the exposure value stored on another smaller CSE pixel [act 518]. As described above with respect to act 504, controller 108 may implement act 518 by supplying a row select control signal to at least a portion of array 102 along one or more of row address lines 212. Process 500 may then repeat some or all of acts 506-514 for this new smaller CSE exposure value.

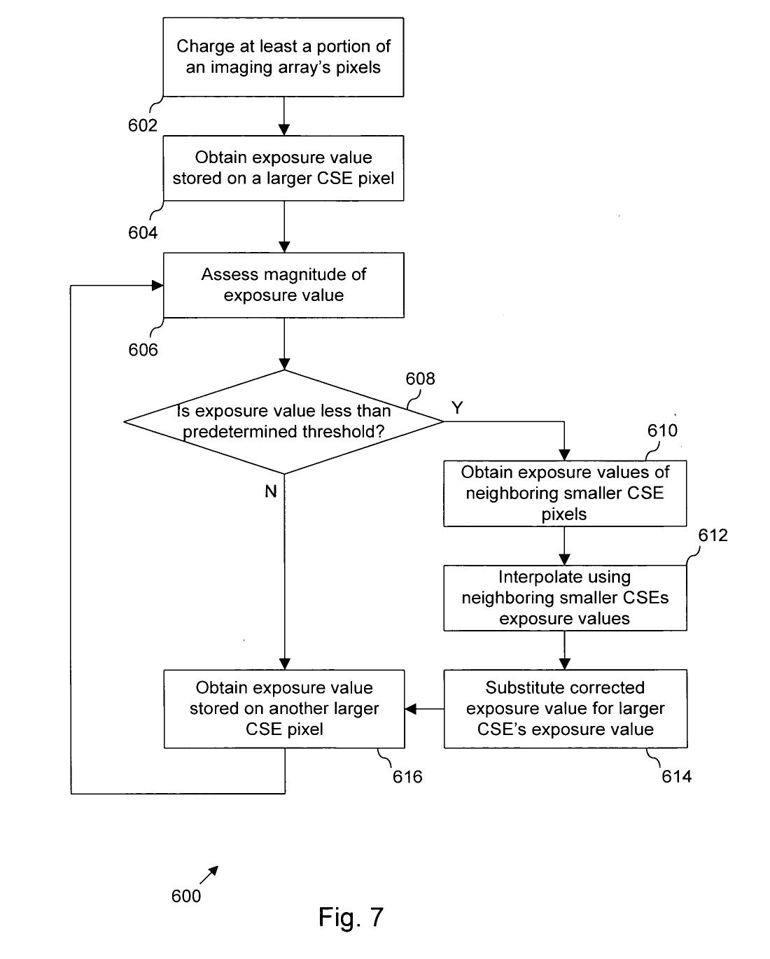

FIG. 7 is a flow diagram illustrating a process 600 for implementing CMOS image sensor array optimization for both bright and low light conditions in accordance with some implementations of the invention. While, for ease of explanation, process 600, and associated processes, may be described with regard to system 100 of FIG. 1, respective array portions 200 and/or 250 of FIGS. 2-3 and/or the adjacent pixels of FIGS. 4-5, the invention is not limited in this regard and other processes or schemes supported and/or performed by appropriate devices and/or combinations of devices in accordance with the claimed invention are possible.

Process 600 may begin with charging at least a portion of an imaging array's pixels [act 602]. In some implementations, control logic in controller 108 may initiate a charge transfer control signal to at least a portion of array 102 in a manner similar to that described above with respect to act 502 of process 500 (FIG. 6).

Process 600 may continue with obtaining the signal value or exposure value stored on a larger CSE pixel [act 604]. In some implementations, control logic in controller 108 may obtain the larger CSE exposure value in a manner similar to that described above with respect to act 504 of process 500 (FIG. 6). That is, for example, the control logic may supply a row select control signal to device 310 of pixel 302 causing that pixel to supply the exposure value stored on larger CSE 314 to one of column lines 214 and ultimately to processing logic in controller 108.

Process 600 may continue with an assessment of the magnitude of the exposure value of the larger CSE exposure value [act 606]. In some implementations, processing logic in controller 108 may undertake act 606. A determination may then be made of whether the signal magnitude is equal to or less than a threshold value [act 608]. One way to do this is to have the processing logic compare the magnitude of the exposure value obtained in act 606 to a predetermined threshold value.

If the result of act 608 is positive, process 600 may continue with the obtaining of two or more neighboring smaller CSE exposure values [act 610]. As those skilled in the art will recognize, the signal obtained from a larger CSE may have a larger noise component (e.g., comprising KTC noise, photonic shot noise etc.) for a given signal magnitude than that of a smaller CSE for that same signal magnitude. Hence, in accordance with the invention, the S/N ratio of the exposure or signal values obtained from an array such as array 102 may be improved by substituting exposure values obtained from smaller CSEs for those obtained from larger CSEs when the magnitude of the signal obtained from a larger CSE falls below a pre-determined threshold where that threshold may be a function of array design elements such as the sizes and types of CSEs employed.

In one implementation, control logic in controller 108 may obtain adjacent or neighboring smaller CSE exposure values in a manner similar to that described above with respect to act 510 of process 500 (FIG. 6). For example, the control logic may, in part, supply a row select control signal to device 310 of pixel 301 (i.e., as one of the smaller CSE pixel neighbors of pixel 302) thereby causing pixel 301 to supply the exposure value stored on smaller CSE 312 to one of column lines 214 and ultimately to processing logic in controller 108. To complete the example using array portion 200, if pixel 201(7) represents smaller CSE pixel 301 and pixel 201(6) represents larger CSE pixel 302, then to accomplish act 610, controller 108 may likewise obtain the CSE exposure or signal values of one or more of the remaining smaller CSE pixel neighbors 201(2), 201(5), and/or 201(10) of larger CSE pixel 201(6). As noted above, those skilled in the art will recognize that there may be intervening circuitry and/or logic facilitating the transfer of the smaller CSE exposure values between array 102 and controller 108 that are not particularly germane to the invention and that have therefore not been included in FIGS. 1-5 in the interests of clarity.

Process 600 may continue with interpolation using the neighboring smaller CSE exposure values [act 612]. In some implementations, if processing logic in controller 108 may undertake the interpolation of act 612 using the smaller CSE exposure values obtained in act 610. For instance, referring again to example array portion 200 of FIG. 2, if the larger CSE exposure value assessed as meeting or falling below the predetermined threshold value in act 608 was obtained from pixel 201(6) then the processing logic may interpolate between two or more of the smaller CSE exposure values of pixels 201(2), 201(5), 201(7) and/or 201 (10) obtained in act 610 to determine a corrected exposure value in act 612. For example, the processing logic may determine the average value, (i.e., mean value) from two or more of the exposure values of pixels 201(2), 201(5), 201(7) and/or 201(10) and use that value as an corrected exposure value. However, the invention is not limited by the type of interpolation employed in act 612 and other methods of interpolation, such as, for example, determining the median value of the smaller CSE exposure values, may be implemented in act 612 in accordance with the invention.

Process 600 may continue with substitution of the corrected exposure value for the larger CSE exposure value [act 614]. In some implementations, the processing logic may substitute the corrected exposure value obtained in act 612 for the larger CSE exposure value obtained in act 604. In other words, the processing logic may discard the larger CSE exposure value obtained in act 604 and replace that exposure value with the corrected exposure value obtained from the neighboring smaller CSE exposure values in act 612.

Process 600 may continue with obtaining of the exposure value stored on another larger CSE pixel [act 616]. As described above with respect to act 604, controller 108 may implement act 616 by supplying a row select control signal to at least a portion of array 102 along one or more of row address lines 212. Process 600 may then repeat some or all of acts 606-614 for this new larger CSE exposure value.

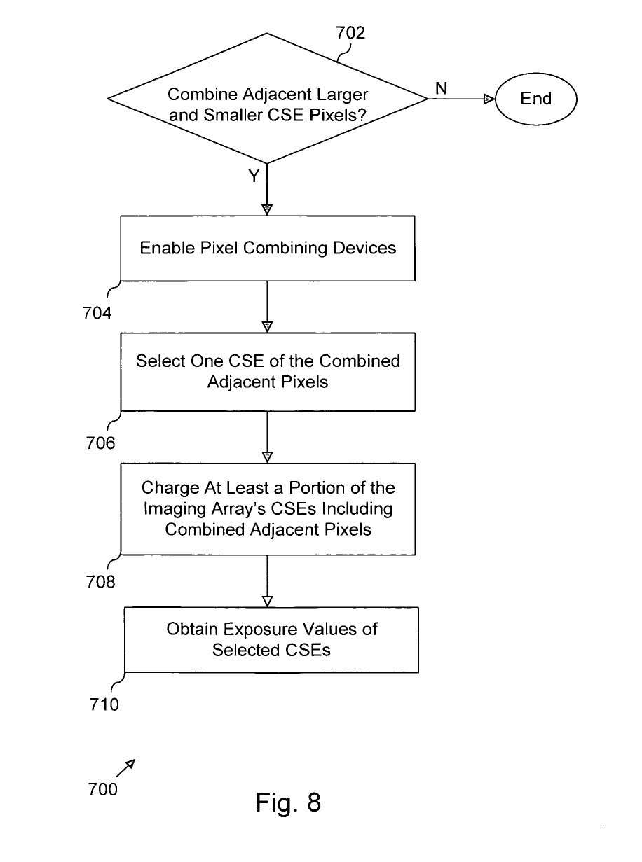

FIG. 8 is a flow diagram illustrating a process 700 for implementing CMOS image sensor array optimization for both bright and low light conditions in accordance with some implementations of the claimed invention. While, for ease of explanation, process 700, and associated processes, may be described with regard to system 100 of FIG. 1, respective array portions 200 and/or 250 of FIGS. 2-3 and/or the adjacent pixels of FIGS. 4-5, the invention is not limited in this regard and other processes or schemes supported and/or performed by appropriate devices and/or combinations of devices in accordance with the claimed invention are possible.

Process 700 may begin with an assessment of whether to combine adjacent larger CSE and smaller CSE pixels [act 702]. In some implementations, controller 108 may undertake act 702. For example, processing and/or control logic in controller 108 may determine, based on ambient conditions surrounding system 100, that a shorter exposure time is desirable and, hence, that selectively combining adjacent smaller CSE and larger CSE pixels to enable both photocurrent sources or photodiodes to charge either the larger or the smaller CSEs may be desirable. The invention is, however, not limited by what logic and/or device undertakes the assessment of act 702.

If the outcome of act 702 is negative, that is if it is determined that adjacent pixels are not to be combined, then process 700 may terminate. If, on the other hand, the outcome of act 702 is positive, that is if it is determined that adjacent pixels are to be combined, then process 700 may continue with an enablement of the pixel combining devices [act 704]. In some implementations, act 704 may be undertaken by having controller 108 provide a photodiode combine (PD combine) signal to combine device 416 of adjacent smaller CSE/larger CSE pixels 401/402. In doing so, controller 108 may enable both photodiodes 404 of the adjacent, and now combined pixels 401/402 to charge either larger CSE 414 or smaller CSE 412.

Process 700 may continue with the selection of one CSE of the combined adjacent pixels [act 706]. In some implementations, controller 108 may supply a charge transfer control signal to one of charge transfer devices 406 of adjacent pixels 401 and 402. Thus, for example, controller 108 could undertake act 706 by supplying a control signal to device 406 of smaller CSE pixel 401 thereby enabling photodiodes 404 of both pixels 401 and 402 to provide charge to smaller CSE 412. Alternatively, controller 108 could undertake act 706 by supplying a control signal to device 406 of larger CSE pixel 402 thereby enabling photodiodes 404 of both pixels 401 and 402 to provide charge to larger CSE 414.

Once act 706 has been undertaken, process 700 may continue with the charging of combined adjacent pixels [act 708]. In some implementations, controller 108 may supply a charge transfer signal to the charge transfer device of the pixel whose CSE was selected in act 706. For example, if act 706 results in the CSE of pixel 401 being selected then act 708 may comprise controller 108 supplying a charge transfer signal to device 406 of pixel 401. Alternatively, if act 706 results in the CSE of pixel 402 being selected then act 708 may comprise controller 108 supplying a charge transfer signal to device 406 of pixel 402.

Process 700 may then continue with obtaining the stored exposure values of the selected pixel CSEs [act 710]. One way to do this is to have controller 108 supply a row select signal to the row select device 410 of the pixel having the CSE selected in act 706 and charged in act 708. For example, if act 708 results in the CSE of pixel 401 being charged then act 710 may comprise controller 108 supplying a row select signal to device 410 of pixel 401. Alternatively, if act 708 results in the CSE of pixel 402 being charged then act 710 may comprise controller 108 supplying a charge transfer signal to device 410 of pixel 402.

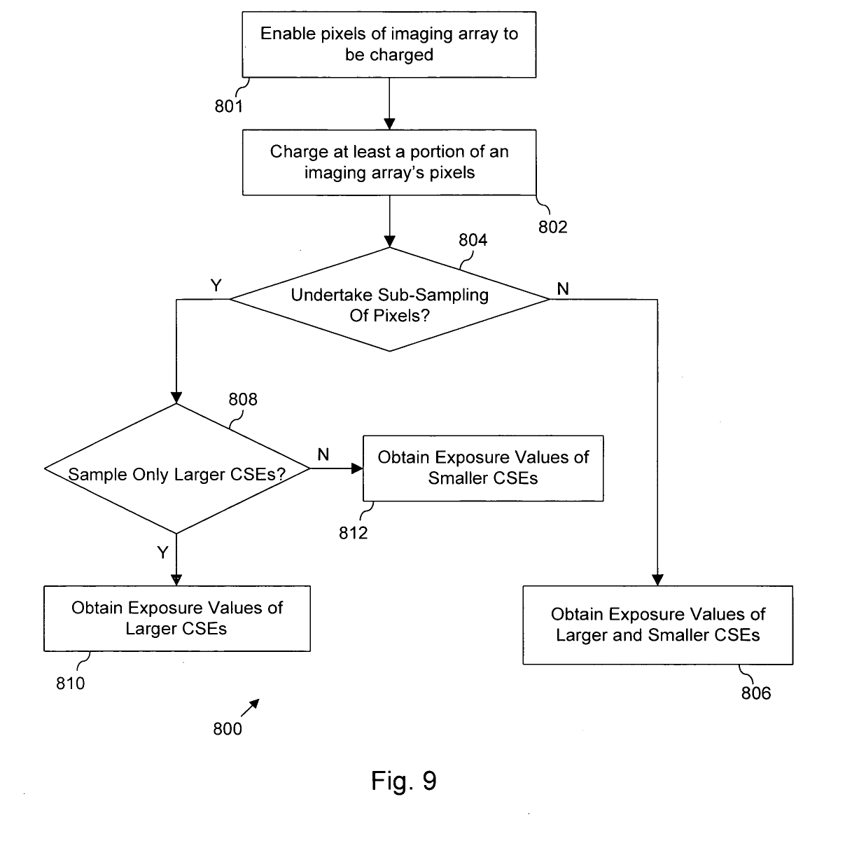

FIG. 9 is a flow diagram illustrating a process 800 for implementing CMOS image sensor array optimization for both bright and low light conditions in accordance with some implementations of the claimed invention. While, for ease of explanation, process 800, and associated processes, may be described with regard to system 100 of FIG. 1, respective array portions 200 and/or 250 of FIGS. 2-3 and/or the adjacent pixels of FIGS. 4-5, the invention is not limited in this regard and other processes or schemes supported and/or performed by appropriate devices and/or combinations of devices in accordance with the claimed invention are possible.

Process 800 may begin with the enabling of an imaging array's pixels to be charged [act 801]. In some implementations, controller 108 may supply a charge transfer signal to devices 306 of the pixels of array 102. Process 800 may continue with the charging of at least a portion of an imaging array's pixels [act 802]. In some implementations, photodiodes 304 of the pixels of array 102 may provide photocurrent to CSEs 312 and 314. Process 800 may then continue with a determination of whether to undertake sub-sampling of the pixels [act 804]. In accordance with the invention, array 102 may be sub-sampled by choosing to read only smaller CSE or only larger CSE pixels. Thus, for example, in undertaking act 804, controller 108 may determine that low light conditions existed during act 802 and hence a greater signal-to-noise ratio may be obtained by sampling only the smaller CSE pixels of array 102. Alternatively, controller 108 may determine that bright light conditions existed during act 802 and hence a greater pixel well dynamic response may be obtained by sampling only the larger CSE pixels of array 102.

If the result of act 804 is negative, that is, if sub-sampling is not undertaken then process 800 may proceed to obtaining the stored exposure values of both larger and smaller CSEs [act 806]. In that case, act 806 may be undertaken by having controller 108 supply a row select signal to the row select devices of both pixel types 301 and 302 of array 102. If the result of act 804 is positive, that is, if sub-sampling is undertaken then process 800 may proceed to a determination of whether to sample only larger CSEs [act 808]. In some implementations, controller 108 may undertake act 808 in response to the lighting conditions present when act 802 occurred. For example, as described above, controller may determine that bright light conditions prevailed during act 802 and, hence, act 808 should result in a positive determination. In that case, process 800 may continue with the obtaining of the exposure values on the larger CSEs [act 810]. This can be done by having controller 108 supply a row select signal to devices 310 of larger CSE pixels 302.

If the result of act 808 is negative, that is, if sampling of larger CSE pixels is not undertaken then process 800 may proceed with the obtaining of the exposure values stored on the smaller CSEs [act 812]. This can be done by having controller 108 supply a row select signal to device 310 of pixels 301. For example, act 812 may be undertaken when controller 108 has determined that low light conditions prevailed during act 802 and, hence, act 808 should result in a negative determination so that smaller CSE rather than larger CSE pixels should be sampled.

The acts shown in FIGS. 6-9 need not be implemented in the order shown; nor do all of the acts necessarily need to be performed. For example, obtaining exposure values [such as in acts 504 and 510] can happen at anytime. Also, those acts that are not dependent on other acts may be performed in parallel with the other acts. For example, acts 504 and 510 may be undertaken simultaneously for pixels in the same row of array 102. Moreover, some acts of processes 500-800 may be implemented in and/or undertaken using hardware and/or firmware and/or software. For example, the acts in process 500 of reading out obtaining values (e.g., acts 504 and 510) may be implemented using hardware and/or firmware, while other acts such as interpolating (act 512) and/or substituting (act 514) may be implemented in software. However, the invention is not limited in this regard and acts that may be implemented in hardware and/or firmware may, alternatively, be implemented in software. Clearly, many such combinations of software and/or hardware and/or firmware implementation of processes 500-800 may be contemplated consistent with the scope and spirit of the invention. Further, at least some of the acts in processes 500-800 may be implemented as instructions, or groups of instructions, implemented in a machine-readable medium.

In accordance with implementations of the invention, area optimization of an image sensor array for both bright light and low light by use of differently sized CSEs may enhance image quality by increasing the effective number of bits (ENOBs) of the array and may allow for the correction of image quality on a per-pixel basis (e.g., by interpolation or other correction derived from differently sized CSEs). As described in detail above, an array in accordance with implementations of the invention may use smaller sized CSEs to provide lower read noise and better image quality in low light conditions and may use larger sized CSEs to provide extended dynamic range by permitting the collection of more photo-induced electrons.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. Clearly, many implementations may be employed to provide a method, apparatus and/or system to implement CMOS image sensor array optimization for both bright and low light applications consistent with the claimed invention.

No element, act, or instruction used in the description of the present application should be construed as critical or essential to the invention unless explicitly described as such. Also, as used herein, the article “a” is intended to include one or more items. In addition, some terms used to describe implementations of the invention, such as “data” and “value,” or “exposure value” and “signal value” may be used interchangeably in some circumstances. In addition, those skilled in the art will recognize that the terms “charge storage element”, “capacitor” and “capacitance” may be used interchangeably without departing from the scope and spirit of the invention. Moreover, when terms such as “coupled” or “responsive” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. An apparatus comprising:
an imaging array, the array including at least pixels of a first type having a first charge storage capacity and pixels of a second type having a second charge storage capacity.

2. The apparatus of claim 1, wherein the ratio of the first charge storage capacity to the second charge storage capacity is at least 1:1.0625.

3. The apparatus of claim 1, the array further comprising:
a plurality of combining devices, each combining device coupling at least some adjacent pixels of the first and second types to form pixel pairs, the combining device enabling photocurrent from both pixels of a pixel pair to be stored on either pixel of the pixel pair.

4. The apparatus of claim 1, wherein the imaging array comprises rows and columns, wherein each row comprises alternating pixels of the first and second types, and wherein each column comprises alternating pixels of the first and second types.

5. The apparatus of claim 1, further comprising:
processing logic coupled to the imaging array, wherein for a given pixel of the first type the processing logic is at least capable of obtaining exposure values stored on at least some neighboring pixels of the second type and of interpolating among those exposure values to determine a corrected exposure value for the pixel of the first type.

6. The apparatus of claim 5, wherein for a given pixel of the second type the processing logic is further capable of interpolating among exposure values of two or more neighboring pixels of the first type to determine a corrected exposure value for the pixel of the second type if an exposure value of the pixel of the second type falls below a predetermined threshold.

7. The apparatus of claim 1, further comprising:
pixels of a third type having a third charge storage capacity.

8. A method comprising:
obtaining exposure values from pixels of an imaging array, the array including at least pixels of a first type having a first charge storage capacity and pixels of a second type having a second charge storage capacity; and
determining a corrected exposure value for a pixel of the first type by interpolating among exposure values of at least some neighboring pixels of the second type.

9. The method of claim 8, further comprising:
assessing the magnitude of an exposure value of a pixel of the second type; and
substituting a corrected exposure value for the exposure value of the pixel of the second type if the magnitude of the exposure value of the pixel of the second type value does not exceed a predetermined threshold, wherein the corrected exposure value is obtained by interpolating over exposure values of two or more pixels of the first type adjacent to the pixel of the second type.

10. The method of claim 8, wherein the ratio of the first charge storage capacity to the second charge storage capacity is at least 1:1.0625.

11. A method comprising:
enabling pixels of an imaging array to be charged, the array including at least pixels of a first type having a first charge storage element and pixels of a second type having a second charge storage element, each pixel of the first type and each pixel of the second type having a source of photocurrent, the first and second charge storage elements having different charge storage capacities; and
charging the pixels of the imaging array with photocurrent.

12. The method of claim 11, further comprising:
combining a pixel of the first type with a pixel of the second type to form a pixel pair;
wherein charging the pixels comprises:
selectively enabling the photocurrent sources of the pixel pair to charge either the first charge storage element or the second charge storage element of the pixel pair.

13. The method of claim 11, further comprising:
obtaining exposure values of either the pixels of the first type or pixels of the second type.

14. The method of claim 11, wherein the ratio of the charge storage capacities of the first charge storage element to the second charge storage element is at least 1:1.0625.

15. A system comprising:
an imaging array, the array including at least pixels of a first type having first charge storage capacity and pixels of a second type having second charge storage capacity;
a controller coupled to the imaging array, the controller to provide control signals to the imaging array; and
an antenna coupled to the controller through an input/output (I/O) interface.

16. The system of claim 15, wherein the controller includes processing logic, wherein for a given pixel of the first type the processing logic is at least capable of obtaining exposure values stored on at least some neighboring pixels of the second type and of interpolating among those exposure values to determine a corrected exposure value for the pixel of the first type.

17. The system of claim 16, wherein for a given pixel of the second type the processing logic is further capable of interpolating among exposure values of two or more neighboring pixels of the first type to determine a corrected exposure value for the pixel of the second type if an exposure value of the pixel of the second type falls below a predetermined threshold.

18. The system of claim 15, wherein the ratio of the charge storage capacity of pixels of the first type to the charge storage capacity of pixels of the first type is at least 1:1.0625.

19. The system of claim 15, wherein the imaging array comprises rows and columns, wherein each row comprises alternating pixels of the first and second types, and wherein each column comprises alternating pixels of the first and second types.

20. The system of claim 15, the array further comprising:
a plurality of combining devices, each combining device coupling at least some adjacent pixels of the first and second types to form pixel pairs, the combining device enabling photocurrent from both pixels of a pixel pair to be stored on the either the pixel of the first type or the pixel of the second type of the pixel pair.

21. The system of claim 15, wherein the antenna is one of a dipole antenna, narrowband Meander Line Antenna (MLA), wideband MLA, inverted “F” antenna, planar inverted “F” antenna, Goubau antenna, or Patch antenna.

22. The system of claim 15, further comprising:
an image processor coupled to the imaging array.

23. The system of claim 22, wherein the image processor is one of a display processor, a multimedia processor or a printer processor.

24. The system of claim 15, further comprising:
pixels of a third type having third charge storage capacity.
